(19) United States
(12) Patent Application Publication
(10) Pub. No.: US 2007/0181258 A1
(43) Pub. Date: Aug. 9, 2007

(54) System for producing rolls of air-filled cushioning material

(75) Inventors: William Morris Robinson, Palo Alto, CA (US); Charles Daigle, San Jose, CA (US); Stephen B. Boyd, Merrimac, MA (US); Douglas A. Johnson, Groveland, MA (US)

Correspondence Address: EDWARD S. WRIGHT, 1100 ALMA STREET, SUITE 207, MENLO PARK, CA, 94025, US

(73) Assignee: FREE-FLOW PACKAGING INTERNATIONAL, INC., Redwood City, CA (US)

(21) Appl. No.: 11/734,500

(22) Filed: Apr. 12, 2007

Related U.S. Application Data
(63) Continuation-in-part of application No. 10/982,600, filed on Nov. 5, 2004.

(51) Int. Cl. B32B 41/00; B32B 37/00; G05G 15/00; B29C 65/00

(52) U.S. Cl. 156/351; 156/443; 156/446; 156/361; 53/403; 156/352

(57) ABSTRACT

System for producing rolls of air-filled cushioning material which includes a machine for inflating and sealing a preconfigured film material to form a continuous sheet of air-filled cushioning material, and a winder having a spindle for receiving the inflated cushioning material from the machine, a drive motor for rotating the spindle to wind the inflated cushioning material into a roll on the spindle, and means for controlling the motor in accordance with the diameter of the roll to maintain substantially uniform tension in the material as the material is wound into the roll. In one disclosed embodiment, the diameter of the roll is monitored by a feeler arm, and in another it is determined from the rate at which the spindle is rotating and the rate at which the material is wound onto the roll.

### RELATED APPLICATIONS

Continuation-in-part of Ser. No. 10/982,600, filed Nov. 5, 2004.

### BACKGROUND OF THE INVENTION

1. Field of Invention

This invention pertains generally to cushioning and packing materials and, more particularly, to a system for producing relatively large rolls of air-filled cushioning material.

2. Related Art

In recent years, air-filled packing materials have come into wide use as a cushioning material or void filler in shipping cartons and the like. The earliest such material to find wide acceptance was probably the material commonly known as bubble wrap which comes in the form of plastic sheets sealed together to form a number of relatively small, individual air-filled cells. Those materials are usually stored and shipped in an inflated state, which is not efficient.

More recently, air filled packing and cushioning materials have been provided in an uninflated, but preconfigured form which can be inflated and sealed at the location or site where they are to be used. Such materials are relatively compact and are typically formed into rolls or stacked into boxes for shipment and storage. They come in a variety of different forms, including relatively large, individual cushions and sheets having rows of smaller, interconnected cells. The communication between the cells in a row is advantageous in that it permits the air to shift from between cells to absorb impact loads as well as permitting the material to conform more closely to the contours of objects wrapped in it. Examples of such materials are found in U.S. Pat. Nos. 6,410,119 and 6,761,960. U.S. Pat. No. 7,040,073 discloses a high speed machine which can produce wider sheets of cellular material than had been possible with other machines.

While smaller cushions are conveniently collected and stored in bins until they are used, larger sheets of cushioning materially are generally wound into rolls for distribution and storage. Winding machines heretofore provided for that purpose have been subject to certain limitations and disadvantages such as lack of reliable speed control and dependence on slip clutches for speed control and safety.

### OBJECTS AND SUMMARY OF THE INVENTION

It is, in general, an object of the invention to provide a new and improved system for producing rolls of air-filled cushioning material.

Another object of the invention is to provide a machine of the above character which overcomes the limitations and disadvantages of machines heretofore provided.

These and other objects are achieved in accordance with the invention by providing a system which includes a machine for inflating and sealing a preconfigured film material to form a continuous sheet of air-filled cushioning material, and a winder having a spindle for receiving the inflated cushioning material from the machine, a drive motor for rotating the spindle to wind the inflated cushioning material into a roll on the spindle, a first sensor for monitoring the rate at which the material is wound onto the roll, a second sensor for monitoring the rate at which the spindle rotates, means responsive to signals from the sensors for determining the diameter of the roll, and means for controlling the motor in accordance with the diameter of the roll to maintain substantially uniform tension in the material as the material is wound onto the roll.

### BRIEF DESCRIPTION OF THE DRAWINGS

FIG. 1 is an isometric view of one embodiment of a system for producing rolls of air-filled cushioning material in accordance with the invention.

FIG. 2 is an elevational view of the winding machine in the embodiment of FIG. 1.

FIG. 3 is a fragmentary elevational view of the drive motor and pulleys in the winding machine in the embodiment of FIG. 1.

FIG. 4 is a fragmentary isometric view of the control mechanism in the winding machine in the embodiment of FIG. 1.

FIG. 5 is an isometric view of another embodiment of a system for producing rolls of air-filled cushioning material in accordance with the invention.

FIG. 6 is an elevational view of the winding machine in the embodiment of FIG. 5.

FIG. 7 is an isometric view, partly broken away, of a guide arm assembly in the embodiment of FIG. 5.

FIG. 8 is a simplified block diagram of the control system in the embodiment of FIG. 5.

### DETAILED DESCRIPTION

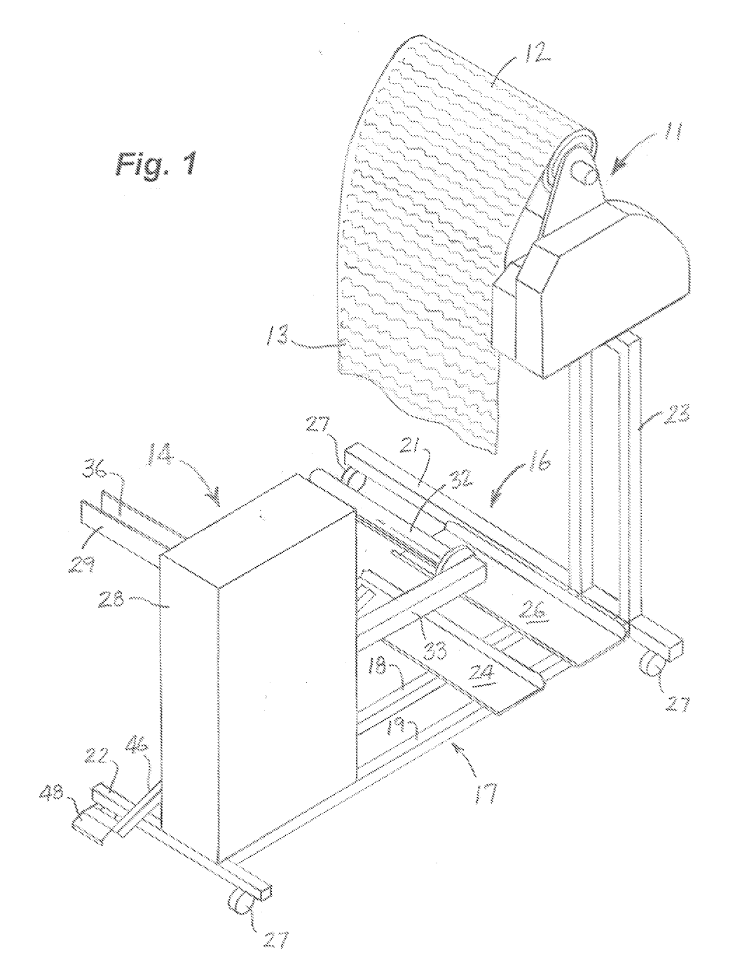

As illustrated in FIG. 1, the system includes a machine 11 for inflating and sealing a preconfigured film material 12 to form a continuous sheet 13 of air-filled cushioning material, a winding machine 14 for winding the inflated material into a roll, and a cart 16 on which the two machines are mounted.

The machine for inflating and sealing the film material can, for example, be of the type disclosed in U.S. Pat. No. 7,040,073, the disclosure of which is incorporated herein by reference. That machine uses a film material which has two layers of a suitable plastic material such as polyethylene that are sealed together to form a longitudinally extending inflation channel along one edge of the material and rows of interconnected, inflatable cells which extend laterally across the material. Inlet passageways interconnect the inflation channel and the first cell in each of the rows, and relatively narrow passageways interconnect adjacent cells within the rows. The rows of cells are formed by undulating seal lines which are offset from each other such that the flow passageways in one row are adjacent to the cells in the rows on either side of it, and the adjacent cells and passageways are formed by common seals with no dead space between them. Rows of perforations extend across the material at periodic intervals to facilitate tearing the material into desired lengths for use.

The machine engages the edge portion of the material near the inflation channel and feeds the material along an inflation tube which extends into the inflation channel and injects air into the cells. It then seals the material across the inlet passageways to retain the air in the cells.

The cart has a horizontally extending frame or base 17 with longitudinally extending rails 18, 19 and cross members 21, 22. Inflating and sealing machine 11 is mounted on a stand 23 at one end of the base, and winding machine 14 rests upon rails toward the other. A pair of laterally extending trays 24, 26 are mounted on the rails between the two machines for holding spare rolls of the preconfigured film material. Casters or wheels 27 are mounted on the under sides of cross members 21, 22 and permit the system to be moved readily from one location to another.

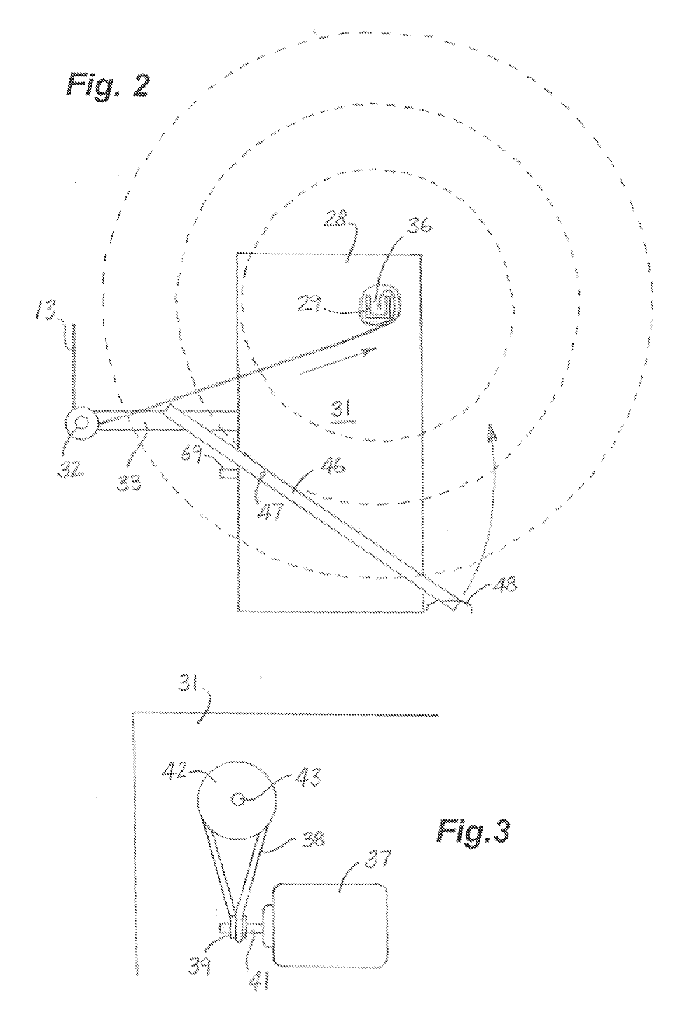

The winding machine has a generally rectangular housing or base 28, with a spindle 29 for receiving the inflated cushioning material and winding it into a roll. The spindle extends horizontally from a side wall 31 of the housing and in a direction generally parallel to the supply roll 12 on the inflating and sealing machine. A horizontally extending guide roller 32 is mounted on an arm 33 which extends from an end wall 34 of the housing toward the inflating and sealing machine. As best seen in FIG. 2, the inflated cushioning material is discharged in a downward direction from the inflating and sealing machine and is trained about the under side of the guide roller before being wound onto the spindle.

In the embodiment illustrated, spindle 29 has a generally U-shaped cross section that defines a channel 36 into which the end portion of the inflated cushioning material can be stuffed to hold the material on the spindle as the winding process begins.

As illustrated in FIG. 3, the spindle is rotated about its axis by a drive motor 37 which is mounted on the inner side of housing wall 31, with a drive belt 38 trained about a drive pulley 39 on motor shaft 41 and a driven pulley 42 on spindle shaft 43. The two shafts and, hence, the pulleys mounted on them are perpendicular to each other, and the drive belt is twisted as it passes between them. The belt has a circular cross section, and the combination of that cross section and the twisting of the belt have been found to be surprisingly effective both in maintaining good control over the roll as the material is wound onto it and in permitting slippage in the event that rotation of the spindle is impeded, e.g., if the hand of an operator should get caught in the roll.

Means is provided for monitoring the diameter of the roll and adjusting the speed of the motor to maintain uniform tension in the material as it is wound onto the roll. This means includes a dancer arm 46 which is mounted on a shaft 47 for rotation about a pivot axis, with a feeler 48 at the lower end of the arm which is urged into peripheral engagement with the roll by suitable means such as a torsion spring 49, weights on the upper portion the arm, or a combination of thereof.

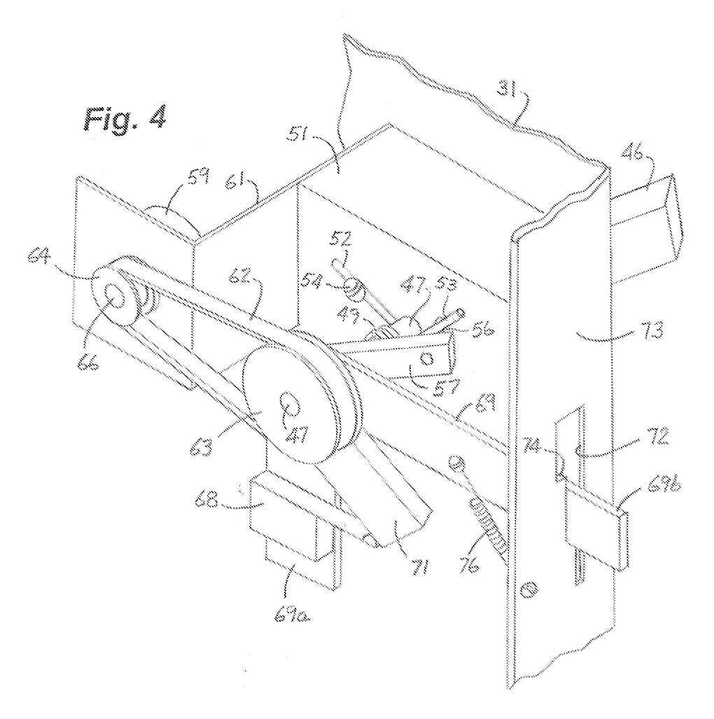

As illustrated in FIG. 4, dancer arm shaft 47 is rotatively mounted in a bearing block 51 on the inner side of housing wall 31. Torsion spring 49 is disposed coaxially of the shaft, with the arms 52, 53 of the spring bearing against a screw 54 on the bearing block and a pin 56 carried by an arm 57 affixed to the shaft.

The position of the dancer arm is monitored by a potentiometer 59 mounted on a bracket 61 attached to bearing block 51. The potentiometer is driven by a belt 62 trained about pulleys 63, 64 which are affixed to shaft 47 and to the shaft 66 of the potentiometer. The potentiometer is connected to a motor controller which increases the power applied to drive motor 37, and hence the speed of the motor, as the diameter of the roll increases.

Means is also provided for shutting the motor down when the roll reaches a predetermined diameter. This means includes a micro switch 68 mounted on one leg 69a of an L-shaped control arm 69 which is pivotally mounted on shaft 47 and actuated by a radially extending cam 71 affixed to the shaft. The other leg of the control arm extends through an opening 72 in the end wall 73 of enclosure 28 and can be moved between different detent stops 74 to change the position of the micro switch relative to the cam. In the embodiment illustrated, three detent stops are provided, corresponding to roll diameters of 24, 36 and 48 inches. The control arm is urged into engagement with the detent steps by a coil spring 76 connected between the control arm and the wall of the enclosure, with the point of connection to the wall being below and to the rear of the connection to the arm.

Operation and use of the system is as follows. The film material is inflated and sealed by machine 11, then trained about the lower side of guide roller 32, with the end portion of the material being brought around the under side of spindle 29 and then stuffed into channel 36. Control lever 69 is set for the desired roll size, and drive motor 37 is turned on to rotate the spindle about its axis. As the material is discharged from the inflating and sealing machine, it is wound into a roll on the spindle, and the size of the roll is monitored by dancer arm 46 and feeler 48. As the diameter of the roll increases, potentiometer 59 signals the motor controller to increase the power to the motor to maintain uniform tension into the material being wound onto the roll. When the roll reaches the diameter set by control arm 69, micro switch 68 is actuated and signals the controller to remove the power from the motor.

In the event that something should impede the rotation of the spindle, motor belt 38 will slip until the obstruction is cleared.

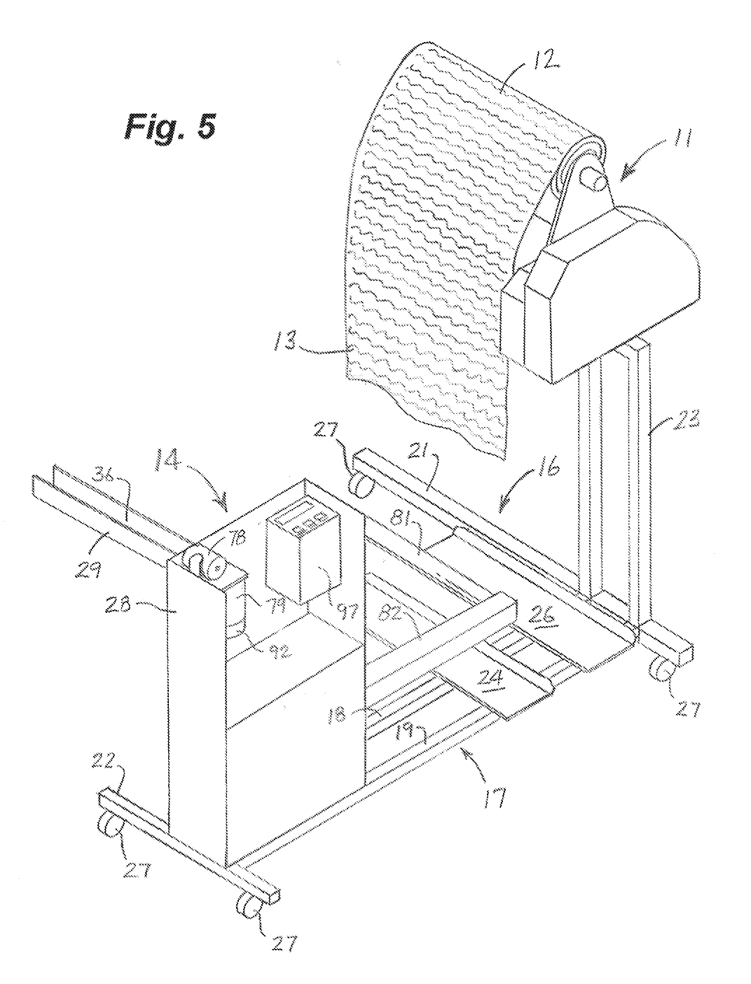

The embodiment of FIG. 5 also includes a machine 11 for inflating and sealing a preconfigured film material 12 to form a continuous sheet 13 of air-filled cushioning material, a winding machine 14 for winding the inflated material into a roll, and a cart 16 on which the two machines are mounted. The inflating and sealing machine and the cart are similar to those in the embodiment of FIG. 1, and like reference numerals designate corresponding elements in the two embodiments.

In the embodiment of FIG. 5, spindle 29 is mounted in a one-way bearing 78 and driven by a gear motor 79. The bearing permits the spindle to turn in the forward direction only and prevents the roll from backing up and loosening the outermost layers of the material in it. The gear motor is a DC motor having a torque output which is directly proportional to the current delivered to the motor. As in the embodiment of FIG. 1, the operation of the motor is controlled to maintain substantially uniform tension in the cushioning material as it is wound onto the roll.

A horizontally extending guide arm 81 is mounted in a fixed position on a beam 82 which extends from side wall 34 of winder housing 28 toward inflating and sealing machine 11. The arm has a tubular cylindrical body 83 with a mounting bracket 84 on the upper side of the body. The guide arm and beam are both mounted in cantilevered fashion, and a guide wheel 86 is rotatively mounted on the free end of the guide arm. This wheel is of larger diameter than the body of the arm, and it helps to guide wider sheets of material which extend beyond the end of the arm.

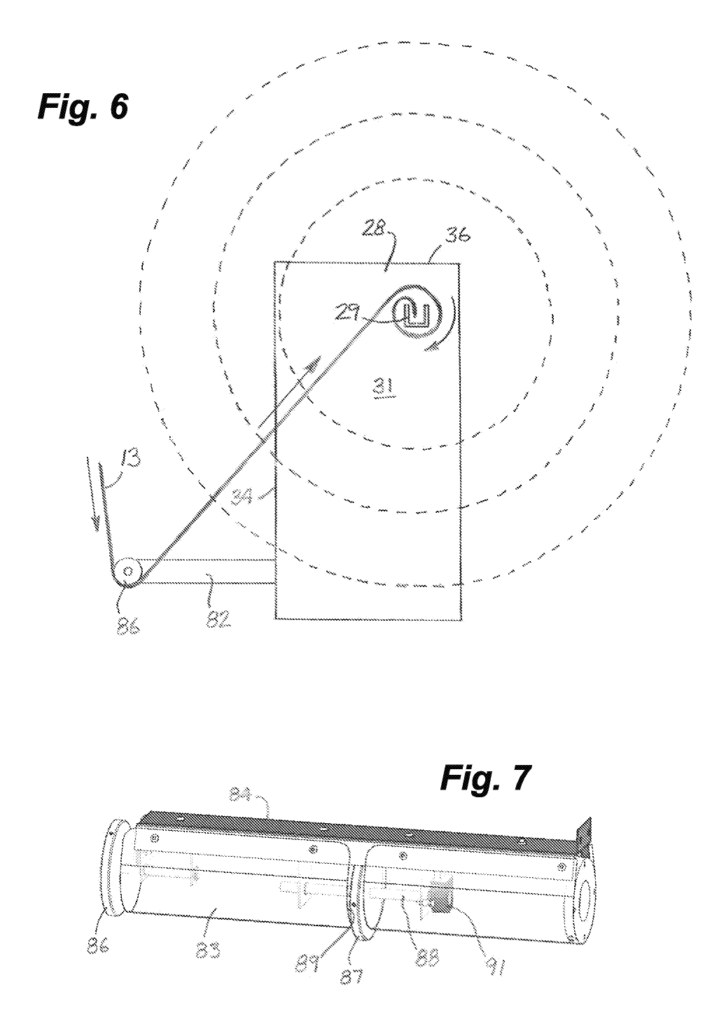

As best seen in FIG. 6, the inflated cushioning material is discharged in a downward direction from the inflating and sealing machine and is trained about the under side of the guide arm before being wound onto the spindle. The material passes about the arm at a fairly sharp angle, which effectively isolates the inflating and sealing machine from forces generated by the winding torque. This eliminates harmful tugging which can cause poor inflation of the material. The arm is also positioned far enough below the machine to permit the use a mechanism for partially pre-tearing the material along its lines of perforation as it leaves the machine.

A sensing wheel 87 is mounted on guide arm 81 for monitoring the amount of material which is delivered to the roll. This wheel is mounted on a shaft 88 within the arm and projects through a slot 89 which opens through the lower and lateral sides of the arm. The wheel is driven by the cushioning material as it passes about the arm, and the rate at which the wheel rotates and, hence, the amount of material delivered to the roll are monitored by an encoder 91 coupled to the shaft. The sensing wheel is positioned midway between the ends of the shaft for use with both narrower and wider sheets of material.

In the embodiment illustrated, guide wheel 86 and sensing wheel 87 are equal in diameter to ensure that the cushioning material runs true and is not skewed as it passes around the arm. The sensing wheel is, however, offset below the guide wheel to ensure engagement with the cushioning material.

A second shaft encoder 92 is coupled to the shaft of drive motor 79 for monitoring the rate at which the spindle is turning. The two encoders produce pulses at rates corresponding to the rotational speeds of the shafts to which they are connected.

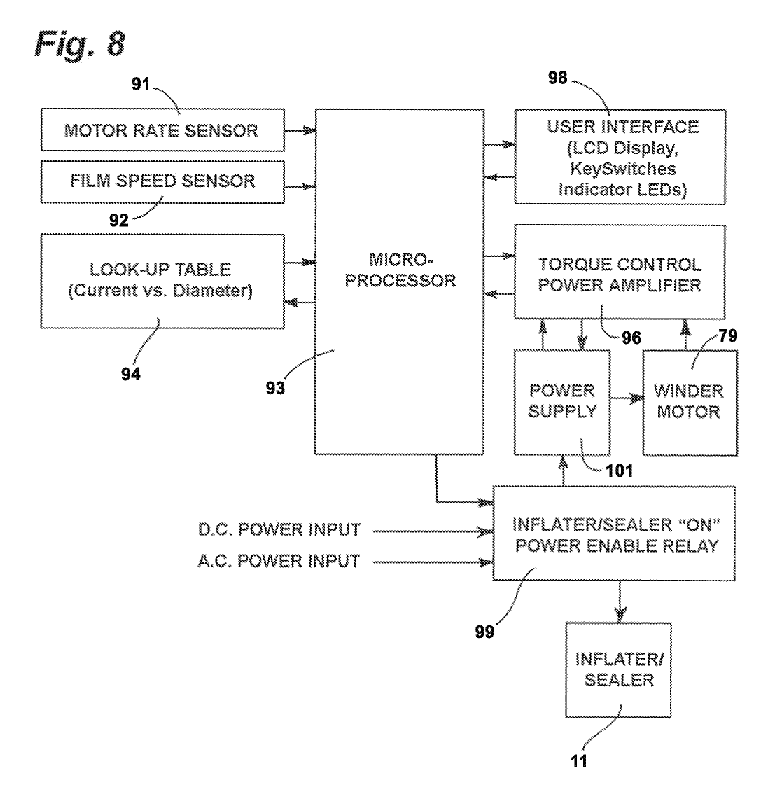

As illustrated in FIG. 8, the rate signals from the encoders are monitored by a microprocessor 93 which is programmed to determine the diameter of the roll according to the relationship
D=ω_{d}/ω_{D} d,
where D is the diameter of the roll, ω_{d} is the rate of rotation of the sensing wheel, ω_{D} is the rate of rotation of the roll, and d is the diameter of the sensing wheel. In one presently preferred embodiment, the sensing wheel is chosen to have a circumference of 12 inches, a length commonly used in commercial measurement.

The relationship between roll diameter and the current to be applied to the motor to maintain substantially uniform tension in the cushioning material is stored in a look-up table 94 such as the following, which can be accessed by the microprocessor:

TABLE 1

| Roll Diameter | Motor Current |
|---|---|
| (Inches) | (Amperes) |
| 0 | 0.3 |
| 3 | 0.3 |
| 6 | 0.4 |
| 9 | 0.4 |
| 12 | 0.5 |
| 15 | 0.6 |
| 18 | 0.7 |
| 21 | 0.8 |
| 24 | 0.9 |
| 27 | 0.9 |
| 30 | 1.0 |
| 33 | 1.1 |
| 36 | 1.2 |
| 39 | 1.3 |
| 42 | 1.4 |
| 45 | 1.5 |
| 48 | 1.6 |

The values shown in this table are exemplary only and in practice will be determined by factors such as the tension desired in the material and the characteristics of the motor employed in the winder. The microprocessor provides a signal to a motor controller 96 which controls the amount of current flowing through the motor. In one presently preferred embodiment, the motor controller is a pulse width modulated power amplifier.

The microprocessor, motor controller, and memory for storing the look-up table are part of a system controller 97 which is mounted in the upper portion of winder housing 28 and includes a user interface 98 with an LCD display, indicator LEDs, and key switches through which the operator controls the operation of the system. This controller also includes a solid state relay 99 which controls the application of operating power both to the inflater/sealer and to the winder under the control of the microprocessor and input from the operator through the user interface.

A.C. operating power for inflater/sealer 11 is applied to relay 99 and delivered to the inflater/sealer by the relay to turn that machine on and off. When the inflater/sealer is on, the relay also delivers A.C. input power to a power supply 101 which supplies the operating current to winder motor 79. This power supply includes a sensor for monitoring the current delivered to the motor, and the signal from that sensor is applied to motor controller 96. The current from the motor passes through the motor controller and back to power supply 101.

As can be seen from Table 1 above, the amount of current applied to the winder motor is increased as the diameter of the roll increases. At start-up, for example, the motor receives about 0.3 amperes of current. That current is maintained until the diameter of the roll reaches about 6 inches, at which point the current is increased to 0.4 amperes. The current continues to be increased in steps until the roll reaches the desired diameter, at which point both the winding motor and the inflating and sealing machine are stopped. That can be done either automatically or manually.

The additional torque produced by the increased current keeps the motor turning at the proper speed to maintain the desired tension in the material. In the event the motor speed should drop, the controller will increase the current to bring the motor back to the proper speed. If the roll is not turning within a predetermined range of speeds, the controller will cause the system to stop winding and alert the operator. Similarly, if the motor current is outside the normal range, the controller will take corrective action and/or shut the system down and notify the operator.

The invention has a number of important features and advantages. It produces relatively large rolls of inflated cushioning material quickly and easily, and it permits the roll size to be selected in advance. Such rolls might, for example, have a width of 30 inches and a diameter of 24, 36 or 48 inches. The system maintains uniform tension in the material, which is important from the standpoint of maintaining control over the material and producing tight, well-formed rolls, and it provides reliable speed control and safety without the use of slip clutches.

It is apparent from the foregoing that a new and improved system for producing rolls of air-filled cushioning material has been provided. While only certain presently preferred embodiments have been described in detail, as will be apparent to those familiar with the art, certain changes and modifications can be made without departing from the scope of the invention as defined by the following claims.

1. A system for producing a roll of inflated cushioning material, comprising:
a cart, a machine on the cart for inflating and sealing a preconfigured film material to form a continuous sheet of air-filled cushioning material, and a winder on the cart having a spindle for receiving the inflated cushioning material from the machine, a drive motor for rotating the spindle to wind the inflated cushioning material into a roll on the spindle, a first sensor for monitoring the rate at which the material is wound onto the roll, a second sensor for monitoring the rate at which the spindle rotates, means responsive to signals from the sensors for determining the diameter of the roll, and means for controlling the motor in accordance with the diameter of the roll to maintain substantially uniform tension in the material as the material is wound into the roll.

2. The system of claim 1 wherein the means for controlling the motor includes means for increasing the speed of the motor as the diameter of the roll increases.

3. The system of claim 1 wherein the first sensor comprises an encoder which monitors the rate of rotation of a wheel about which the inflated cushioning material is trained between the machine and the spindle.

4. The system of claim 1 wherein the second sensor comprises an encoder which monitors the speed of the drive motor.

5. A system for producing a roll of inflated cushioning material, comprising:
a spindle, a motor for rotating the spindle to wind an elongated length of inflated cushioning material into a roll on the spindle, a first sensor for monitoring the rate at which the material is wound onto the roll, a second sensor for monitoring the rate at which the spindle rotates, means responsive to signals from the sensors for determining the diameter of the roll, and means for applying more power to the motor as the diameter of the roll increases.

6. The system of claim 5 wherein the first sensor comprises an encoder which monitors the rate of rotation of a wheel about which the inflated cushioning material is trained as it is wound onto the roll.

7. The system of claim 5 wherein the second sensor comprises an encoder which monitors the speed of the motor.

8. A system for producing a roll of inflated cushioning material, comprising:
a machine for inflating and sealing a preconfigured film material to form a continuous sheet of air-filled cushioning material, a winder having a spindle for receiving the inflated cushioning material from the machine, a drive motor for rotating the spindle to wind the inflated cushioning material into a roll on the spindle, an arm about which the inflated cushioning material is trained in passing from the machine to the spindle, a sensing wheel rotatively mounted on the arm for engagement with the cushioning material as it passes about the arm, a first sensor responsive to rotation of the sensing wheel for monitoring the rate at which the material is wound onto the roll, a second sensor for monitoring the rate at which the spindle rotates, means responsive to signals from the sensors for determining the diameter of the roll, and means for controlling the motor in accordance with the diameter of the roll to maintain substantially uniform tension in the material as the material is wound into the roll.

9. The system of claim 8 wherein the sensing wheel is positioned toward the center of the arm.

10. The system of claim 8 including a second wheel at one end of the arm for rotatively supporting the cushioning material as it passes about the arm.

11. The system of claim 8 wherein the arm about which the material is trained is positioned so that the material passing about the arm makes an angle which effectively isolates the inflating and sealing machine from forces generated by winding torque.
